(19) United States
(12) Patent Application Publication
(10) Pub. No.: US 2023/0059744 A1
(43) Pub. Date: Feb. 23, 2023

(54) EXOSKELETON FOR MOBILE DEVICES

(71) Applicant: David Petrosian Mkervali, Wilmington, DE (US)

(72) Inventor: David Petrosian Mkervali, Wilmington, DE (US)

(21) Appl. No.: 17/405,352

(22) Filed: Aug. 18, 2021

(51) Int. Cl. B25J 13/00; B25J 9/00

(52) U.S. Cl. CPC B25J 13/006; B25J 9/0006; B25J 5/007

(57) ABSTRACT

The current invention proposes an advance form of exoskeleton for mobile devices formation of various new types of robots that allow solving problems of various classes using additional functional modules within the framework of the EMD concept. It further allows a significant expansion of the functionality of mobile devices, which—with the help of a specialized external frame can move in space and carry out various useful interactions with the outside world using removable working (instrumental) modules. This structure allows to reduce the cost of robotics by using standard mobile devices equipped with appropriate software as operators of various types of exoskeletons. The specified technical result is achieved by combining the functionality of the exoskeleton (a specialized external frame), which allows you to move in space and interact with the environment, and various mobile devices (smartphones, tablets, smartwatches).

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

Embodiments disclosed herein generally relate to methods, apparatus and systems for providing an exoskeleton for mobile device. More particularly, the invention relates to a device for the implementation of various kinds of mechanical (including transport, amplifying, manipulative) and others (including sensory-communicative, control, analytical, search and etc.) operations, characterized in that it contains: a) an external frame controlled by a mobile device, including a transport chassis and/or a system of manipulators and leading parts, as well as, optionally, a set of modular slots for mounting mobile devices, additional electronics, tools for various purposes, sensors complementing basic sensors in mobile devices, b) a mobile device (smartphone, tablet, laptop or their combination of any complexity), c) software and/or hardware required to control the EMD.

### DESCRIPTION OF THE RELATED ART

With the continuous improvement of living standards, people are increasingly high requirements for the quality of life. The Robotic exoskeletons are wearable electromechanical devices that have been developed as augmentative devices to enhance the physical performance of the wearer or as orthotic devices for gait rehabilitation or locomotion assistance. These enable users with appropriate physical abilities to stand, walk, climb stairs and perform ADL (Miller et al., 2016). According to the Food and Drug Administration (FDA) a powered exoskeleton is ‘a prescription device that is composed of an external, powered, motorized orthosis used for medical purposes that is placed over a person's paralyzed or weakened limbs for the purpose of providing ambulation.

Robotic exoskeletons involve sensors, actuators, mechanical structures, algorithms, and control strategies capable of acquiring information to execute a motor function. A key feature of exoskeletons is the direct interaction between human and device. This aspect could be divided into cognitive human-robot interaction (cHRI) and physical human-robot interaction (pHRI). cHRI relates to how the user controls the exoskeleton. pHRI relates to the application of controlled forces between human and exoskeleton.

These analogous devices make it possible to provide assistance to people with limited functions and assist servicemen in increasing the speed of their movement and building muscle strength in combat conditions, but all of them re-quire an operator for their functioning—a person dressed in an exoskeleton.

In addition, they do not solve the problem of significantly expanding the functionality of mobile devices and (at the same time) reducing the cost of robotics.

By looking at prior art multiple types of advancements have been seen. For instance, an Exoskeleton bearing US patent 2,008,0009771A1 is issued to University of Washington. This patent discloses, among other things, a wearable structure having links and joints corresponding to those of a human upper body. Transducers are located on the wearable structure and are coupled to a processor. The transducers exchange energy and information between the user and the wearable structure and enable control of the movement of the structure.

Another US patent 2,003,0115954A1 on Upper extremity exoskeleton structure and method is issued to Vladimir ZemlyakovPatrick McDonough. The assembly is adjustable to a user's upper extremity the exoskeleton structure provides testing and exercising of the whole upper extremity in a realistic manner without infringement of a locomotor act and with selective biomechanical information and exercise loading in each anatomical motion direction of every joint simultaneously. The exoskeleton structure comprises jointed means for connection with a user's shouldergirdle, upper arm, forearm, and hand. Those means include measuring-loading blocks to measure muscle forces and joint angles and to apply a dosed exercise load. All measuring-loading blocks in the exoskeleton structure are identical. The exoskeleton structure is able to provide a realistic and comprehensive information about both a complex locomotor act and a selective mono-planar motion for both isometric and isotonic muscular contractions.

Another patent on Portable Arm Exoskeleton for Shoulder Rehabilitation bearing US patent 2,007,0225620A1 is issued to Craig R. CarignanMichael Scott Liszka. The present invention relates to an exoskeleton interface apparatus that parallels human arm motion and is comprised of a serial assemblage of five powered linkages and joints based at a rigid support structure worn on the torso of the human subject. Such apparatus generates shoulder rotation using three orthogonal revolute joints mounted on serial linkages encompassing and intersecting at the anatomical glenohumeral joint. Elevation of the shoulder joint is articulated using a link member driven by a single revolute joint mounted in the torso structure. Passive adjustable linkages are used to match variation in anatomical forearm length, upper arm length, and scapula-to-glenohumeral radius. A plurality of integrated dc motor/harmonic drive transmission modules is co-located on adjoining linkages to power the joints. Force is exchanged with the human at the handgrip and elbow brace, and reacted to the torso structure via the base attachment. The present invention is applicable in particular to rehabilitation of the shoulder.

A US patent 2,008,0188907A1 on Controller for an Assistive Exoskeleton Based on Active Impedance is issued to Honda Motor Co Ltd Northwestern University. The invention discusses system and method are presented to provide assist to a user by means of an exoskeleton with a controller capable of making the exoskeleton display active impedance. The exoskeleton assists the user by reducing the muscle effort required by the user to move his or her extremities. In one embodiment, a single-degree-of-freedom (1-DOF) exoskeleton assists a user with single-joint movement using an active impedance controller. In another embodiment, a multiple-degree-of-freedom (multi-DOF) exoskeleton assists a user with multiple-joint movement using an active impedance controller.

A WO patent 2,008,131563A1 Robotic exoskeleton for limb movement is issued to Stephen H. ScottIan E. BrownStephen J. Ball. The invention relates to a robotic exoskeleton comprising mechanical linkages that couple to one or more selected joints of a limb of a subject. The robotic exoskeleton may be provided with means for obtaining data respecting angular position, torque, and/or acceleration of at least one of the joints or the links of the mechanical linkages, and may be used for assessing, studying, diagnosing a deficit, and/or treating an impairment in sensorimotor function of a limb of a subject.

An exoskeleton and method for controlling a swing leg of the exoskeleton bearing U.S. Patent 2,010,011848A1 is issued to Homayoon KazerooniKurt AmundsonRussdon AngoldNathan Harding. The patent discusses a lower extremity exoskeleton (100), configurable to be coupled to a person, includes two leg supports (101, 102) configurable to be coupled to the person's lower limbs, an exoskeleton trunk (109) configurable to be coupled to the person's upper body, which is rotatably connectable to the thigh links (103, 104) of the leg supports (101, 102) allowing for the flexion and extension between the leg supports (101, 102) and the exoskeleton trunk (100), two hip actuators (145, 146) configured to create torques between the exoskeleton trunk (109) and the leg supports (101, 102), and at least one power unit (201) capable of providing power to the hip actuators (145, 146) wherein the power unit (201) is configured to cause the hip actuator (145, 146) of the leg support (101, 102) in the swing phase to create a torque profile such that force from the exoskeleton leg support (101, 102) onto the person's lower limb during at least a portion of the swing phase is in the direction of the person's lower limb swing velocity.

Another patent on Exoskeleton bearing U.S. patent 2,012,175211A1 is issued to Patoglu VOLKAN. The present invention relates to an exoskeleton for humans comprising a joint element, that interacts directly or indirectly with a human's joint via an end-effector mount, wherein the end-effector mount is arranged to perform an arbitrary planar parallel movement in a plane, allowing superimposed translational and rotational movements of the end-effector mount relative to a body of the joint element.

Multiple inventions have been proposed art regarding bringing advancement and enhanced utility regarding exoskeleton for humankind. Mobile devices could use the same approach to get improvements and enhanced functions. The technical result of the invention is: a) acceleration of the formation of various new types of robots that allow solving problems of various classes using additional functional modules within the framework of the EMD concept; b) expansion of the functionality of mobile devices, which—with the help of a specialized external frame—can move in space and carry out various useful interactions with the outside world using removable working (instrumental) modules; c) reducing the cost of robotics by using standard mobile devices equipped with appropriate software as operators of various types of exoskeletons.

The specified technical result is achieved by combining the functionality of the exoskeleton (a specialized external frame), which allows you to move in space and interact with the environment, and various mobile devices (smartphones, tab-lets, laptops).

The nearest prototypes (see, for example, RU 2552703, JP 2011143243, US 2013231595, NZ 20080586912) do not solve the problem of significantly expanding the functionality of mobile devices and reducing the cost of robotics, since their main task is to help people with disabilities to make up for functions and military personnel (to increase the speed of movement and muscle strength in combat conditions).

When using an exoskeleton for mobile devices, the problems described above are eliminated, making it possible to create a sufficiently highly efficient multifunctional robot from any mobile device (smartphone, tablet, laptop) connected to the exoskeleton using the appropriate slots and a special software system.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention's general objective is to provide a composition of an exoskeleton crafted for mobile devices (such as mobile phones, tablets, smartwatches, etc.). The use of exoskeleton crafted for mobile devices would allow mobile phones, tablets, and smartwatches to acquire the ability to perform transporting, amplifying, and manipulative mechanical operations, thus transforming them into robots capable of interacting with the external world.

It is also the objective of the invention to provide an exoskeleton for mobile devices (abbreviated as EMD) as a device designed for the implementation of various kinds of mechanical (including transport, amplifying, manipulative), communicative, control, analytical, search and other operations.

It is further the objective of the invention to provide a structure which contains: a) an external frame controlled by a mobile device, including a transport chassis and/or a system of manipulators and leading parts, as well as, optionally, a set of modular slots for mounting mobile devices, additional electronics, tools for various purposes, sensors complementing basic sensors in mobile devices, b) a mobile device (smartphone, tablet, laptop or their combination of any complexity), c) software and/or hardware required to control the EMD.

It is another object to provide an improved, convenient and safe assembly which promotes ease for the consumer where it integrates with mobile devices of any type by means of: a) wireless communication technologies (including through personal wireless networks such as Bluetooth, Wireless USB, Etc.), b) local wireless networks (including Wi-Fi and RONIJA), c) global networks (including WiMAX, HiperMAN, WiBro, Classic WaveLAN, Etc.), d) mobile networks (including 3G, 4G, 5G, Etc.) and e) satellite networks.

It is another object to disclose a method to introduce an exoskeleton for mobile devices (EMD), characterized in that it is intended for activities within one or several environments: a) on land (including on rough terrain), b) on water and/or under water, c) in the air—in the form of an unmanned aerial vehicle.

It is also the objective of the invention to provide Exoskeleton for mobile devices (EMD), characterized by the presence of machine learning mechanisms for acquiring new knowledge, skills and abilities in order to adapt their behavior to the environment.

More specifically, it is the principal object of this invention to provide an architecture of exoskeleton for mobile devices (EMD), characterized in that it is able to integrate into groups with similar devices and perform (as part of such groups) complex tasks that exceed the sum of the functionality of all participants.

It is also the objective of the system to provide an architecture of Exoskeleton for mobile devices (EMD), characterized in that it is made in a compact version not exceeding a size of 20 cm in length, width, and height.

According to another aspect, it is also the objective of the invention to provide an exoskeleton for mobile devices (EMD) able (depending on the configuration and quality of the software) to solve tasks of various complexity levels in the industrial, construction and transport areas, in the spheres of communication, training, security, external observation, entertainment, services, military affairs, etc.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 discloses one of the possible variants of the Exoskeleton for mobile devices designed for movement on land as per preferred embodiments of the invention.

FIG. 2 shows one of the possible versions of the Exoskeleton for mobile devices intended for movement through the air and implemented according to the helicopter scheme as per preferred embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention is directed to provide a Exoskeleton for mobile devices also referred as EMD include (without limiting the generality): movement in different environments, movement of objects and impact on them, communication with people through cloud assistants and speech interpretation systems (Siri from Apple, Alexa from Amazon, Alice from Yandex, etc.), capture the moments and recording events in photo, video and audio formats, emulating pets and game systems of the Tamagotchi class through the mechanical capabilities of the EMD (vibrating alert, rumbling through speakers, winking through camera flash, displaying an animal's face on the screen, etc.) and so on.

An exoskeleton for mobile devices (EMD) as per its preferred embodiments is characterized in that it integrates with mobile devices of any type by means of wireless communication technologies (including through personal wireless networks such as Bluetooth and Wireless USB), local wireless networks (including Wi-Fi and RONIJA), global net-works (including WiMAX, HiperMAN, WiBro, Classic WaveLAN), mobile networks (including 3G, 4G, 5G) and satellite networks.

The exoskeleton for mobile devices (EMD) as per its further embodiments is characterized in that it is intended for activities within one or several environments including but not limited to on land (including on rough terrain), on water and/or under water, in the air—in the form of an unmanned aerial vehicle.

The Exoskeleton for mobile devices (EMD) as per its further embodiments is characterized by the presence of machine learning mechanisms for acquiring new knowledge, skills and abilities in order to adapt their behavior to the environment.

The Exoskeleton for mobile devices (EMD) as per its additional embodiments is characterized in that it is able to integrate into groups with similar devices and perform (as part of such groups) complex tasks that exceed the sum of the functionality of all participants.

The Exoskeleton for mobile devices (EMD) as per its additional embodiments is characterized in that it is made in a compact version not exceeding a size of 20 cm in length, width and height. The presence or absence of the above basic and additional EMD modules is determined by a specific type of EMD.

To connect a mobile device to the EMD, it is necessary to connect it to the slot for integration of the mobile device, fixing it on the external frame of the EMD and connect the software located on the mobile device via wireless communication channels, or through the phone charging connector or tablet. Being mutually integrated, a robotic exoskeleton (a specialized external frame) and an arbitrary mobile device (smartphone, tablet, laptop, etc.) begin to function together as a mobile exoskeleton (EMD).

The exoskeleton for mobile devices (EMD) as per its further embodiments is able (depending on the configuration and quality of the software) to solve tasks of various complexity levels including but not limited to industrial, construction and transport areas, in the spheres of communication, training, security, external observation, entertainment, services, military affairs, etc.

As per its additional embodiments it further includes movement in various environments, moving objects and influencing them, communication with people through cloud assistants and speech interpretation systems (Siri from Apple, Alexa from Amazon, Alice from Yandex, etc.), capturing the moments and recording events taking place in photo, video and audio formats, emulation of pets and game systems of the Tamagotchi class through the mechanical capabilities of the EMD (vibrating alert, rumbling through speakers, winking through a camera flash, displaying an animal's face on the screen, etc.) and so on.

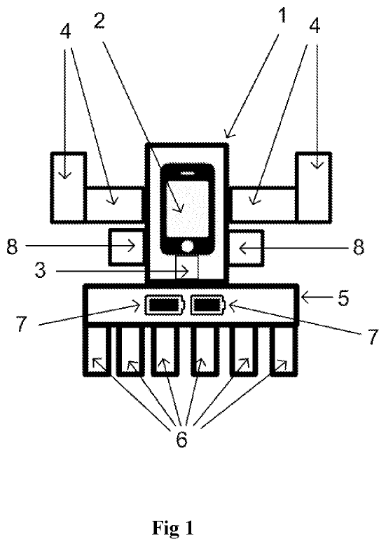

To further describe the images' following description is provided. The FIG. 1 shows one of the possible variants of the Exoskeleton for mobile devices designed for movement on land (including on the floor of various premises, asphalt surfaces, rough terrain, etc.): 1) slot for fixing the mobile device on the EMD case; 2) an integrated mobile device; 3) a system of connectors (jacks) for all types of connection (functional integration) of mobile devices with an exoskeleton (external frame); 4) manipulators; 5) the transport and chassis of the exoskeleton (external frame); 6) wheels built into the chassis of the exoskeleton; 7) batteries; 8) additional modular slots.

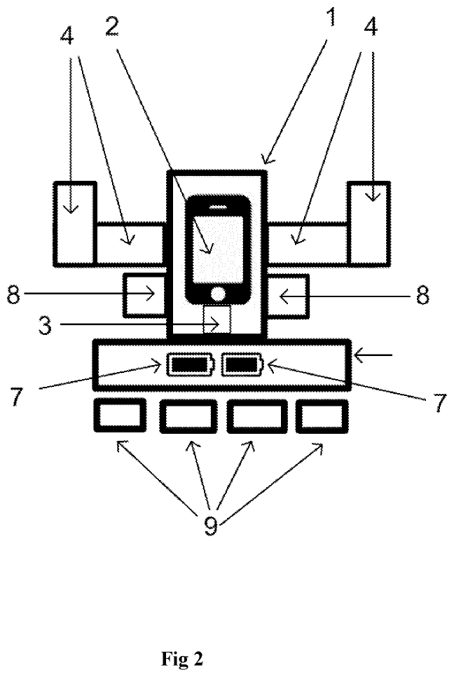

FIG. 2 shows one of the possible versions of the Exoskeleton for mobile devices intended for movement through the air and implemented according to the helicopter scheme: 1) a slot for fixing the mobile device on the EMD case; 2) an integrated mobile device; 3) a system of connectors (jacks) for all types of connection (functional integration) of mobile devices with an exoskeleton (external frame); 4) manipulators; 5) the transport and chassis of the exoskeleton (external frame); 7) one or several batteries; 8) additional modular slots; 9) carrying screws.

While a specific embodiment has been shown and described, many variations are possible. With time, additional features may be employed. The particular shape or configuration of the platform or the interior configuration appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. The current invention proposes an exoskeleton crafted for mobile devices which is a device designed for the implementation of various kinds of mechanical (including transport, amplifying, manipulative) and others (including sensory-communicative, control, analytical, search, etc.) operations by mobile devices, characterized in that it contains: a) an external frame controlled by a mobile device, including a transport chassis and/or a system of manipulators and driving parts, as well as, optionally, a complex of modular slots for mounting mobile devices, additional electronics, tools for various purposes, sensors complementing basic sensors in mobile devices, b) a mobile device (smartphone, tablet, smartwatch or their combination of any level is difficulty), c) software and/or hardware required to control the EMD.

2. The exoskeleton for mobile devices according to claim 1 (EMD), characterized in that it integrates with mobile devices of any type by means of: a) wireless communication technologies (including through personal wireless networks such as Bluetooth and Wireless USB), b) local wireless networks (including Wi-Fi and RONIJA), c) global networks (including WiMAX, HiperMAN, WiBro, Clas-sic WaveLAN), d) mobile networks (including 3G, 4G, 5G) and e) satellite net-works;

3. The exoskeleton for mobile devices according to claim 1 (EMD), characterized in that it is intended for activities within one or more environments: a) on land (including on rough terrain), b) on water and/or under water, c) in air—in the form of an unmanned aerial vehicle;

4. Exoskeleton for mobile devices according to claim 1 (EMD), characterized by the presence of machine learning mechanisms for acquiring new knowledge, skills and abilities in order to adapt its behavior to the environment;

5. Exoskeleton for mobile devices according to claim 1 (EMD), characterized in that it is able to integrate into groups with similar devices and perform (as part of such groups) complex tasks that exceed the sum of the functionality of all participants; and,

6. Exoskeleton for mobile devices according to PP. 1 (EMD), characterized in that it is carried out in a compact version, not exceeding a size of 20 cm in length, width and height.
